(19) United States
(12) Patent Application Publication
(10) Pub. No.: US 2017/0165853 A1
(43) Pub. Date: Jun. 15, 2017

(54) RAZOR WITH MIRROR

(71) Applicants: YVONNE CHEE ON LI, Long Beach, CA (US); ALEXANDER PENN SOTELO, Long Beach, CA (US)

(72) Inventors: YVONNE CHEE ON LI, Long Beach, CA (US); ALEXANDER PENN SOTELO, Long Beach, CA (US)

(21) Appl. No.: 14/970,300

(22) Filed: Dec. 15, 2015

(51) Int. Cl. B26B 21/52; A45D 42/08

(52) U.S. Cl. CPC B26B 21/521; B26B 21/522; A45D 42/08

(57) ABSTRACT

A razor can include a pivoting mirror attached to the razor handle. A wire adaptor may fit inside the razor handle and have ends that extend from one end of the razor handle. Various brands of razor blade assembly may removably attach to the ends of the wire adaptor. A securing mechanism, such as a gel pad, may be disposed within the razor handle on one or both sides of the wire adaptor to prevent slippage of the wire adaptor and provide dampened pivoting of the razor blade assembly.

### BACKGROUND OF THE INVENTION

1. Field of the Invention

The invention relates generally to personal care products, and more particularly to a razor having disposable blades attached via a wire adaptor and a mirror attached to the razor's handle.

2. Description of Prior Art and Related Information

Conventional razors often utilize a handle with a blade that may be removed and replaced as needed. These razors usually have a push button to disengage the blade assembly from the handle and often use complex mechanisms for blade removal and replacement. These mechanisms may fail, requiring a user to purchase a new handle mechanism.

Moreover, conventional razors typically have a straight handle with the blade attached. Some conventional razors are provided with a storage container having a reflective surface. However, to use the reflective surface, the user must hold the mirror-like storage container in one hand while shaving with the other. This can result in difficulty, as only one hand is free for shaving.

As can be seen, there is a need for a razor that may include a reflective element integrated into the razor, allowing the user to shave and see a reflection without requiring both hands. Moreover, there is a need for a razor with a replaceable blade that can be quickly and easily changed out when needed.

### SUMMARY OF THE INVENTION

Embodiments of the present invention provide a personal care product that includes a removable blade assembly and an adjustable mirror. Embodiments of the present invention include an adjustable mirror on the handle of the personal care product. The mirror can be attached to the handle in such a manner that permits the mirror to freely pivot in any direction yet retains its angular orientation until a force is applied thereto.

Embodiments of the present invention provide a razor blade handle having a wire adaptor with ends extending from the razor blade handle. The ends may removably secure a razor blade assembly thereto.

Embodiments of the present invention provide a gel pad disposed within the razor blade handle, the gel pad supporting the wire adaptor to prevent slippage and provide dampened, resilient movement of the razor blade assembly during use.

In one aspect, the present invention provides razor comprising an elongated handle; a mirror fully angularly adjustably attached to an exterior of the elongated handle; a wire adaptor having spaced apart legs with ends disposed apart by a separation distance, where the ends of the legs of the wire adaptor are configured to receive a razor blade assembly thereto; and a cover fitting onto the elongated handle, covering a portion of the wire adaptor with the legs extending therefrom, the cover securing the wire adaptor to the elongated handle.

In another aspect, the present invention provides razor comprising an elongated handle; a mirror fully angularly adjustably attached to an exterior of the elongated handle; a wire adaptor having spaced apart legs with ends disposed apart by a separation distance, where the ends of the legs of the wire adaptor are configured to receive a razor blade assembly thereto; a cover fitting onto the elongated handle, covering a portion of the wire adaptor with the legs extending therefrom, the cover securing the wire adaptor to the elongated handle; and a gel pad disposed to support at least one side of the wire adaptor within a housing formed in the elongated handle.

In another aspect, the present invention provides a method for attaching a razor blade assembly to a razor handle which comprises exerting a force to resiliently deform a wire adaptor to cause a separation distance between distal ends of a first leg and a second leg of the wire adaptor to decrease; moving a razor blade assembly between the distal ends; and removing the force to allow the separation distance to increase, wherein the razor blade assembly is secured between the distal ends. The method may further include opening a cover on the razor handle; positioning a proximate end of the wire adaptor into an exposed region created by opening the cover; and closing the cover to secure the wire adaptor to the razor handle.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a top view of a razor according to an exemplary embodiment of the present invention;

FIG. 2 is a bottom view of the razor of FIG. 1;

FIG. 3 is a side view of the razor of FIG. 1;

FIG. 4 is an end view of the razor of FIG. 1, with the wire adaptor fitted therein, according to an exemplary embodiment of the present invention;

FIG. 5 is an end view of the razor of FIG. 1, without the wire adaptor fitted therein, according to an exemplary embodiment of the present invention; and

FIG. 6 is a perspective view of the razor of FIG. 1, illustrated with its cover open and a razor blade assembly removed therefrom.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

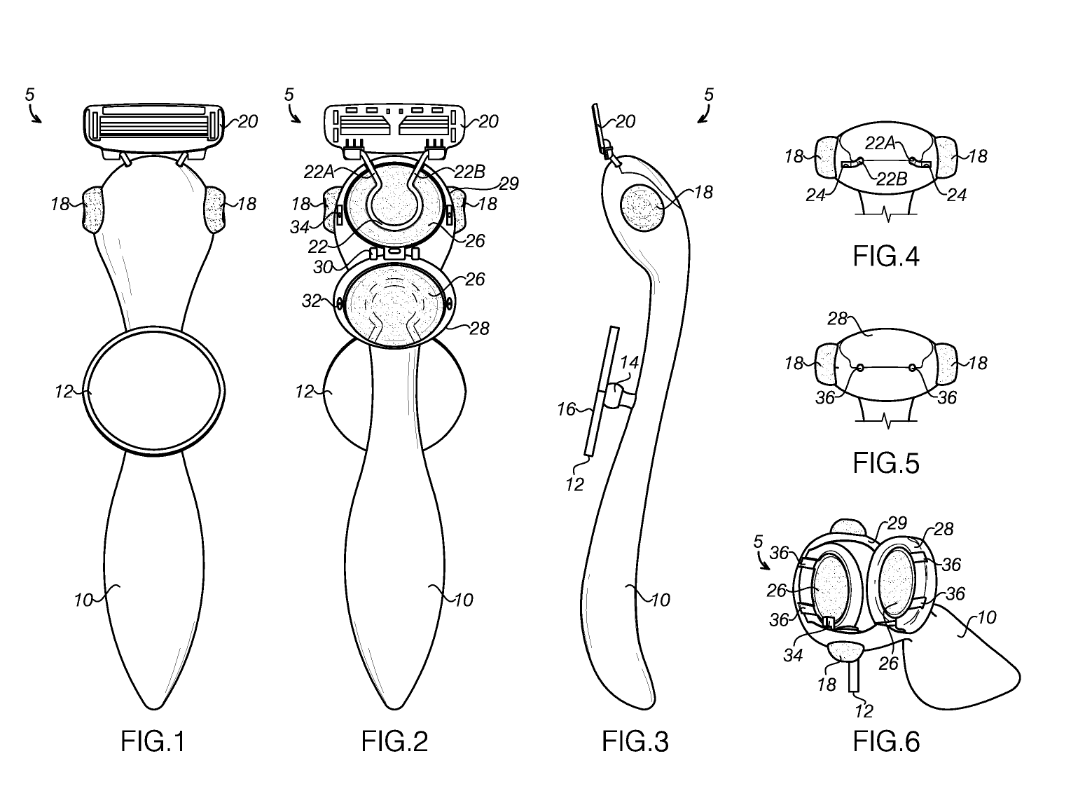

Referring now to FIG. 1 through FIG. 6, a personal care apparatus, such as a razor 5, can include razor handle 10 and a mirror 12 attached thereto. The mirror 12 may be fully, angularly adjustable on the razor handle 10. In other words, when the mirror 12 is in a central position (as shown in FIG. 3, for example), a force may be applied at any position on the outer periphery of the mirror 12 to cause a plane defined by a reflective surface 16 of the mirror 12 to adjust its angle. A pivoting joint, such as a ball joint 14, may be used to attach the mirror 12 to the razor handle 10. The pivoting joint 14 may be configured such that the mirror 12 retains its position when adjusted by a user and does not return to any given position until another force is applied by the user.

The mirror 12 may include a reflective surface 16 for displaying a reflection therein. Typically, the mirror 12 may be attached to a bottom side of the razor handle 10, as illustrated. However, depending on application, the mirror 12 may be positioned at any location on the razor handle 10. In the preferred embodiment, the mirror 12 is approximately positioned at a midpoint along the length of the razor 5.

The mirror 12 may be formed in various shapes. For example, in some embodiments, the mirror 12 may be formed in an oval shape with pointy ends at the oval's major axis. The mirror 12 may be formed from an anti-fogging material to help prevent fogging during use. In some embodiments, the mirror 12 may be attached to a mirror mount which is pivotably attached to the razor handle 10. As used herein, the term “mirror” may be used to describe both the reflective surface itself or the entire assembly, including any mounting surface that may be used.

In some embodiments, the razor 5 may include one or more buttons 18 disposed on the razor handle 10. In some embodiments, the buttons 18 may be disposed on opposite sides of the razor handle 10 at one end thereof. While the Figures show two buttons 18, one button 18 may be used. In some embodiments, there may be no buttons 18 used in the razor 5.

The button 18 may be used to unlatch a cover member 28 to permit removal a razor blade assembly 20 from a housing 29 included in the razor handle 10. The button 18 may be a slide button, a push button, or the like. The cover member 28 may include a cover closing mechanism 32. The razor handle 10 may include a mating base closing mechanism 34, wherein when the cover member 28 is closed, the cover closing mechanism 32 may engage with the base closing mechanism 34 to keep the two elements together. Depressing the button 18 may release the closing mechanisms 32, 34. In some embodiments, there may be no button 18, but the closing mechanisms 32, 34 may be friction fit, snap, fit, a magnetic connection or the like.

The cover member 28 may be connected to the razor handle 10 via a hinge 30. The cover member 28 may snap fit onto the hinge 30 or may be formed integrally therewith. Regardless of assembly, the cover member 28 may be openable to remove the razor blade assembly.

When the cover member 28 is opened, a razor blade assembly 20 may be removed from under the cover member 28. FIG. 6 shows an exemplary razor 5 with its cover open and the wire adaptor 22 and razor blade assembly 20 removed therefrom.

The razor blade assembly 20 may be connected to the razor handle 10 via a wire adaptor 22. The wire adaptor 22 may have opposing legs 22A, 22B that terminate at ends 24 bent away from each other so that the razor blade assembly 20 may fit thereon. When the opposing legs 22A, 22B are squeezed together, the ends 24 may resiliently move closer together to permit the razor blade assembly 20 to be removed or placed upon the ends of the wire adaptor 22.

As used herein, the term “wire”, as used to describe the wire adaptor 22, may include any structure of unibody construction of any shape and of any material with elastic properties (springing action) including metallic structures, plastics, carbon fiber structures, composites, ceramics, and any other future technology materials thereafter. The term “wire” is not meant to imply a circular cross-section, but may include any material, as described above, with any cross-sectional shape, provided that ends of the wire adaptor 22 may be resiliently moved closer together to attach and remove the razor blade assembly 20, as discussed herewithin.

The wire adaptor 22 permits the user to attach any cartridge on the market to the razor handle 10. Unlike conventional razor handles, which are designed to fit a particular brand of razor blades, the razor handle 10 of the present invention, via its wire adaptor 22, allows razor blade assemblies 20 from various manufacturers to be used therewith. The resilient, elastic properties of the wire adaptor 22 creates a springing mechanism that applies force on to the inside walls of the adaptors to hold any manufacturers' razor cartridge adaptors using friction.

The wire adaptor 22, with its opposed ends 24, allows the razor blade assembly 20 to pivot on the axis of the ends 24, resulting in a clean shave at various angles of the razor handle 10.

In some embodiments, the wire adaptor 22 may be secured in the razor handle 10 via one or more gel pads 26. The gel pad 32 may be disposed along at least one side of the wire adaptor 22. In some embodiments, the gel pad 32 may be disposed on one side of the wire adaptor 22 and the other side of the wire adaptor 22 may be supported by the razor handle 10. The gel pad 32 may permit dampened movement of the razor blade assembly 20 during shaving and may also help prevent slippage of the wire adaptor 22 within the razor handle 10. For example, when a force is applied to a blade side of the razor blade assembly 20, the razor blade assembly 20 may softly and resiliently pivot rearward due to the support provided by the gel pad 32. When the force is removed, the razor blade assembly 20 may return to its original position.

The gel pad 32 may be made from various materials that may provide a flexible, resilient material. In some embodiments, the gel pad 32 may be formed from a polyurethane material, for example.

In some embodiments, the gel pads 32 may not be required. In these embodiments, another mechanism may be used to secure the wire adaptor 22 within the handle. For example, the wire adaptor 22 may be made from a magnetically attractive metal and magnets may be disposed within the razor handle 10 to secure the wire adaptor 22 therein.

The razor handle 10 may include openings 36 at its distal end where the wire adaptor 22 extends outward therefrom. In some embodiments, the openings 36 may be in both the cover 28 and the razor handle 10, as shown in FIG. 5. In other embodiments, the openings 36 may be disposed in either of the cover 28 or the razor handle 10, provided that, when the cover 28 is opened, the wire adaptor 22 may be removed from the razor handle 10.

While the razor handle 10 is shown having a particular shape and profile design, the razor handle 10 may be configured with various designs, shapes and the like, provided that a distal end can receive a razor and a mirror is disposed along the handle via a pivoting joint. Similarly, while a particular razor blade assembly 20 is shown, various razor blade assemblies may be used with the razor handle 10 of the present invention.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A razor comprising:
an elongated handle;
a mirror fully angularly adjustably attached to an exterior of the elongated handle;
a wire adaptor having spaced apart legs with ends disposed apart by a separation distance, where the ends of the legs of the wire adaptor are configured to receive a razor blade assembly thereto; and
a cover fitting onto the elongated handle, covering a portion of the wire adaptor with the legs extending therefrom, the cover securing the wire adaptor to the elongated handle.

2. The razor of claim 1, wherein the separation distance decreases between the legs while moving down the wire adaptor from the ends thereof.

3. The razor of claim 2, wherein the legs of the wire adaptor are interconnected opposite the ends thereof.

4. The razor of claim 1, further comprising a connecting member removably securing the cover onto the elongated handle.

5. The razor of claim 4, further comprising a button for releasing the connecting member to permit removal of the cover from the elongated handle.

6. The razor of claim 1, further comprising a hinge connecting the cover to the elongated handle at one side thereof.

7. The razor of claim 1, further comprising a gel pad disposed to support at least one side of the wire adaptor within a housing included in the handle.

8. The razor of claim 7, wherein the gel pad is formed from a polyurethane material.

9. The razor of claim 1, wherein the mirror attaches to the housing with a ball joint.

10. A razor comprising:
an elongated handle;
a mirror fully angularly adjustably attached to an exterior of the elongated handle;
a wire adaptor having spaced apart legs with ends disposed apart by a separation distance, where the ends of the legs of the wire adaptor are configured to receive a razor blade assembly thereto;
a cover fitting onto the elongated handle, covering a portion of the wire adaptor with the legs extending therefrom, the cover securing the wire adaptor to the elongated handle; and
a gel pad disposed to support at least one side of the wire adaptor within a housing formed in the elongated handle.

11. The razor of claim 10, wherein the separation distance decreases between the legs while moving down the wire adaptor from the ends thereof.

12. The razor of claim 11, wherein the legs of the wire adaptor are interconnected opposite the ends thereof.

13. The razor of claim 10, further comprising a button for releasing the connecting member to permit removal of the cover from the elongated handle.

14. The razor of claim 10, further comprising a hinge connecting the cover to the elongated handle at one side thereof.

15. The razor of claim 10, wherein the gel pad is formed from a polyurethane material.

16. A method for attaching a razor blade assembly to a razor handle, comprising:
exerting a force to resiliently deform a wire adaptor to cause a separation distance between distal ends of a first leg and a second leg of the wire adaptor to decrease;
moving a razor blade assembly between the distal ends; and
removing the force to allow the separation distance to increase, wherein the razor blade assembly is secured between the distal ends.

17. The method of 16, wherein distal ends of the first and second legs are bent away from each other.

18. The method of 16, further comprising:
opening a cover on the razor handle;
positioning a proximate end of the wire adaptor into an exposed region created by opening the cover; and
closing the cover to secure the wire adaptor to the razor handle.

19. The method of 18, wherein at least one gel pad is disposed in the exposed region.

20. The method of 16, wherein the razor blade assembly is pivotably secured by the distal ends of the first and second legs of the wire adaptor.
